(19) United States
(12) Patent Application Publication
(10) Pub. No.: US 2004/0218403 A1
(43) Pub. Date: Nov. 4, 2004

(54) Diffusion plate having different section with different refractive indices

(76) Inventors: Charles Leu, Fremont, CA (US); Tai-Cheng Yu, Tu-Chen (TW); Ga-Lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/666,284

(22) Filed: Sep. 18, 2003

(30) Foreign Application Priority Data
Mar. 14, 2003 (TW) 92105712

(51) Int. Cl. G02F 1/1335

(52) U.S. Cl. 362/561

(57) ABSTRACT

Provided is a liquid crystal display with a light emitting flat surface, including a light guide having the emitting surface (232) and a pair of end surfaces. A pair of light sources (220) is arranged correspondingly to the pair of end surfaces. The light guide forms two diffusion sections having different refractive indices, thereby creating a junction surface between the diffusion sections.

### BACKGROUND OF THE INVENTION

1. Field of the Invention

The present invention relates to a diffusion plate, and more particularly to a diffusion plate having diffusion sections with different refractive indices, thereby creating a homogeneous luminance distribution across a liquid crystal display lit by the diffusion plate.

2. Description of Prior Art

A liquid crystal display is capable of displaying a clear and sharp image over a wide area. It is thus used with various devices in which a message or picture needs to be illustrated. However, a liquid crystal itself does not emit light, therefore, it has to be back-lit by a light source to display the messages and/or pictures shown there.

In an ideal liquid crystal display, the backlight most provide light evenly distributed across the entire surface. In addition, the apparatus has to meet the requirements of being small in size, light in weight, bright enough with low power consumption.

U.S. Pat. No. 5,438,484 issued to Kanda et al. discloses a surface lighting device. A variety of prior art surface lighting devices are disclosed in FIG. 1 to 5 of the Kanda patent. The light source arranged in the surface lighting device shown is generally referred to as an “edge-type light source”. Kanda describes the disadvantages of the prior art surface lighting device in detail, i.e. the surface area closer to the light sources are brighter than the central area. According to Kanda's explanation in the specification, “However, as described above, the surface lighting device of an edge type has a low luminance in the central portion between the light sources and a high luminance in the vicinity of the light sources as indicated by a broken line C shown in FIG. 9. This is because the light sources 1a and 1b emit diffusion light and make the vicinity of the light sources 1a and 1b bright while the light emitted from the light sources 1a and 1b mostly reach the opposite light source 1b and 1a to be diffused, respectively, thus making the vicinity of the light sources 1a and 1b brighter. As a result, it is inevitable that the effective light range (effective emission surface) of the foregoing lighting device will become narrower because its overall luminance must be adjusted to latch evenly as a backlight with the lowered luminance between the central portion between the light sources 1a and 1b. Thus, a problem is encountered that the light utilization efficiency for the apparatus as a whole is reduced.” See Column 2, lines 31 to 49.

Kanda provides a solution, such as shown in FIG. 11 to 16, by providing “a light guide configured by a plural light transmitting members joined together, so that the junction surface therebetween crosses the light emitting surface.” As a result and according to Kanda, the luminance emitted from edge-type light sources is evenly distributed across the entire area.

Kanda provides another solution in FIG. 17 to 23, typically shown in FIG. 23. In this application, the light source is arranged directly behind the liquid crystal display, instead of at the edge of a light guide, as shown in FIG. 1 of the Kanda patent. However, this arrangement indeed provides a brighter central displaying area, but creates a problem of color chromaticity across the liquid crystal display. As explained by Kanda in Column 12, lines 19-49. Kanda then uses a “light source having preferably be more blueish than the standard color” to solve the “yellowish” problem.

Aside from use of the “blueish light source”, it is noted that a “light curtain”, reference numeral 14 of FIG. 22, has also been used to reduce the luminance projected toward the display area immediately in front of the light source. It should be easy to appreciate that the more parts used within the liquid crystal display, the more laborious the effort needed to assemble the display. No doubt, the size and weight of the liquid crystal display will inevitably be increased.

U.S. Pat. No. 5,881,201 issued to Khanarian discloses improved lightpipes for backlighting liquid crystal display devices. The lightpipes comprise transparent polymers with scattering centers. A preferred composition for such lightpipes comprises a cycloolefin polymer containing scattering centers from suitable elastomers and inorganic fillers. The inventive lightpipes offer superior scattering efficiency as well as spatial uniformity of scattering and uniformity of scattering across a wide wavelength range.

According to Khanarian, the scattering centers are evenly distributed within the entire light pipe so as to increase the luminance refractive therefrom.

### SUMMARY OF THE INVENTION

It is an object of the present invention to provide a diffusion plate such that the central area thereof is intensively brighter by creating a diffusion area having a different refractive index compared to the rest of the area.

In order to achieve the object set forth, a liquid crystal display with a light emitting flat surface in accordance with the present invention comprises a light guide having the emitting surface, and a pair of end surfaces. A pair of light sources is arranged correspondingly to the pair of end surfaces, wherein the light guide forms a diffusion section having different refractive index compared to the rest of the light guide thereby creating a junction surface crosses the liquid crystal display.

### BRIEF DESCRIPTION OF THE DRAWINGS

FIG. 1 is a perspective view of a liquid crystal display made in accordance with the present invention;

FIG. 2 is a cross sectional view of a diffusion board made in accordance with the present invention; and

FIG. 3 is a top plan view of a light source.

### DETAILED DESCRIPTION OF PREFERRED EMBODIMENTS OF THE INVENTION

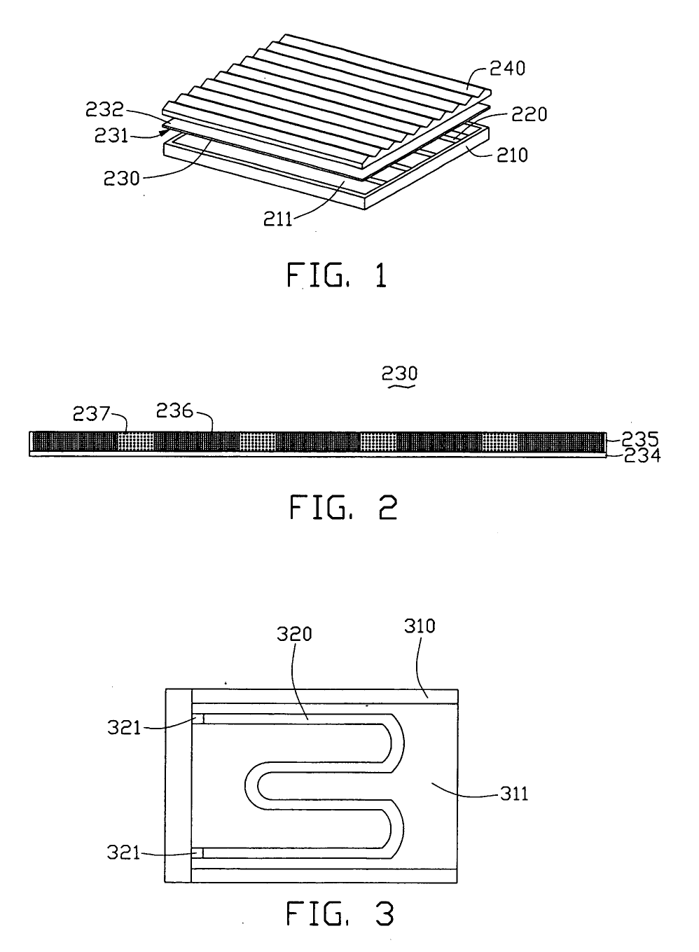

Referring to FIGS. 1 and 2, a liquid crystal display made in accordance with the present invention generally includes a refractor frame 210 in which a plurality of light sources 220 is arranged. The refractor frame 210 further includes a diffusion board 230, and an enhancer 240.

The diffusion board 230 defines an incident surface 231 and an emitting surface 232. The light sources 220 are arranged adjacent to the incident surface 231, while the enhancer 240 is arranged adjacent to the emitting surface 232. The refractor frame 210 is further coated with a reflective film 211 so as to increase the luminance of the light sources 220 by reflecting the light beams emitted therefore.

As mentioned in the prior art, when the light sources 220 are arranged directly beneath the diffusion board 230, it is very likely that a viewer will see the “shadow” of the light because the light beams are emitted directly toward the diffusion board 230. In order to effectively eliminate this unwanted, defective shadow, the diffusion board 230 made in accordance with the present invention provides a unique structure to soften the “shadow”, thereby providing a shadow-free image by completely diffusing light beams projected into portions of the diffusion board 230 directly adjacent the light sources 220.

The diffusion board 230 generally comprises a substrate 234 which is made from highly transparent material. The diffusion board 230 further includes a diffusion layer 235 formed directly upon the substrate 234. The diffusion layer 235 is made from a material such as Polymethyl Methacrylate (known as PMMA) or Polycarbonate (known as PC). The PMMA or PC is further blended with scattering material so as to increase the refractive efficiency thereof. The scattering material is selected from melamine resin or PMMA having a grain size of 5 to 30 micrometers.

Specifically, when the diffusion layer 235 is formed, the diffusion layer 235 is configured to have at least a first areas 236 and a second areas 237. For the most part, the second areas 237 is positioned closer to the light sources 220, while the first areas 236 is positioned away from the light sources 220. In order to eliminate the shadow generated by the light source, the refractive index in the second areas 237 is substantially larger than that in the first areas 236. By this arrangement, the light projected through the second areas 237 is scattered such that the shadow effect fades away.

The diffusion board 230 in accordance with a preferred embodiment of the invention is made using an injection process. The diffusion board 230 is made such that the first areas 236 and the second areas 237 are injected with different materials. For example, the first areas 236 can be injected with normal transparent material, while the second areas 237 can be normal transparent material mixed with the scattering material, i.e. melamine resin or PMMA having a grain size of 5 to 30 micrometers. The two different materials can be precisely positioned within the mold cavity. As a result, the second areas 237, being composed with a high density of scattering material, exhibits a higher refractive index. By this arrangement, the light beams projected from the light sources into portions of the diffusion board 230 nearest the light sources (i.e. the second areas 237) effectively diffused within the diffusion board 230, thereby eliminating the light “shadow”.

It can be easily appreciated that by providing the diffusion board 230 with areas having different refractive indices, the light “shadow” can be effectively eliminated without the use of a light curtain, such as is described in U.S. Pat. No. 5,438,484 issued to Kanda.

In use, the light beam projected from the light source 220 and reflected from the reflective film 211 penetrates into the diffusion board 230, which diffuses the light beam evenly across the diffusion board 230. The refractive indices of the first areas 236 and the second areas 237 are specially tailored such that the light emitted from the emitting surface 232 is evenly distributed. As mentioned above, the second areas 237 are right above the light sources 220, and have a larger refractive index, the light beam penetrates therethrough is largely scattered by the scattering material. After the light beams are evenly emitted from the emitting surface 232, the light beams enter the enhancer 240, which to intensifies its luminance.

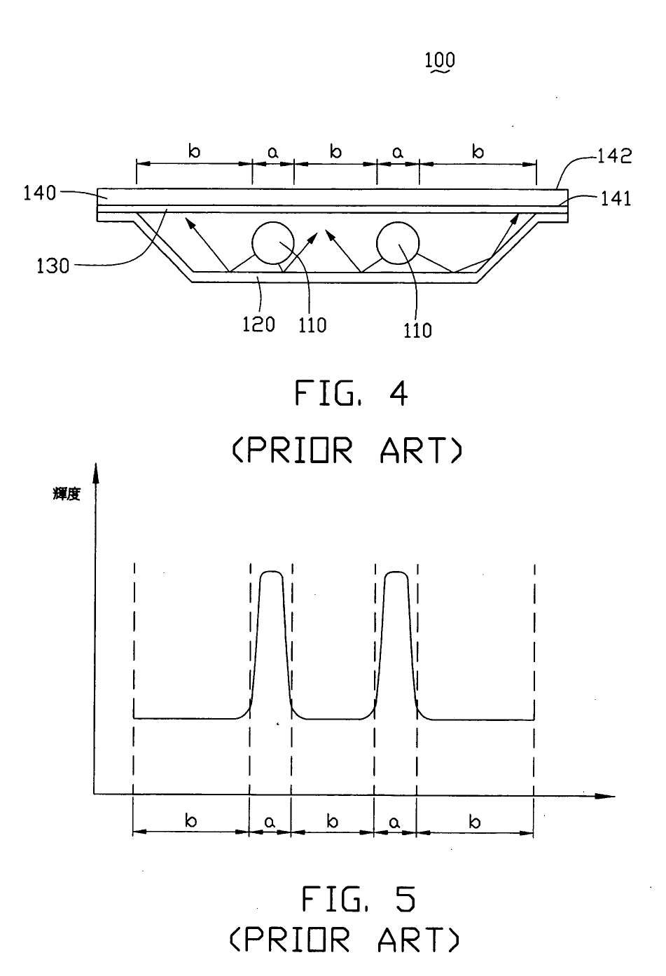

In addition, the second areas 237 in the diffusion board 230 can be arranged so conform to the shape of the light sources. As shown in FIG. 3, the light source 320 arranged within the refractor frame 310 has a W-shaped configuration. The refractor frame 310 is further coated with a reflective film 311 so as to intensify the luminance. The W-shape light source 320 includes a pair of electrodes 321 for powering it. For this type of light source, the second areas 237 on the diffusion board 230 can be made with an arrangement corresponding to the shape of the light source. As a result, the “shadow” effect is again eliminated by the provision of scattering material within the diffusion board.

The embodiments described above are relate to a penetrative type light source, i.e., the light source is arranged under the diffusion board. In cases of side-edge arranged light sources, the basic arrangement provided by the present invention can also be applied.

As shown in FIGS. 11 to 17 of the Kanda '484 patent, the light guide is divided into several sections, i.e., a single light guide comprises several different plates. However, when the basic arrangement in accordance with the present invention is introduced, the physical sections separated by surfaces are replaced by injected areas having higher a lower refractive indices due to higher a lower densities of scattering materials. By this arrangement, an integral light guide plate having different sections bearing a higher and lower densities of scattering materials can easily achieve the effect sought by the Kanda device, while being easier to assemble, handle, and so on than the Kanda device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A liquid crystal display with a light emitting flat surface, comprising:
a light guide having the emitting surface, and a pair of end surfaces; and
a pair of light sources arranged to correspond with the pair of end surfaces;
wherein the light guide forms two diffusion sections having different refractive indices thereby creating a junction surface between diffusion sections.

2. The liquid crystal display as recited in claim 1, wherein the light sources are linear light sources.

3. The liquid crystal display as recited in claim 1, wherein the light sources are linear light sources and the junction surface formed in the light guide is parallel to the linear light sources.

4. The liquid crystal display as recited in claim 1, wherein the junction surface is positioned substantially equal distant from the two light sources.

5. The liquid crystal display as recited in claim 1, wherein the junction surface is formed in the light guide by injection molding two different mixtures of transparent materials and scattering material, the two different mixtures having different refractive indices.

6. The liquid crystal display as recited in claim 1, wherein the light guide comprises a substrate made of highly transparent material.

7. The liquid crystal display as recited in claim 4, wherein the scattering material is formed by polymethyl methacrylate having a grain size ranging from 5 to 30 micrometers.

8. The liquid crystal display as recited in claim 4, wherein the scattering material is formed by melamine resin having a grain size ranging from 5 to 30 micrometers.

9. A liquid crystal display, comprising:
a diffusion board having an emitting surface and an incident surface; and
at least a light source arranged behind the incident surface; wherein the diffusion board forms an ordinary diffusion section and an intensified diffusion section which intensified diffusion section has a refractive index and corresponds in shape and position to the shape and position of the light source, thereby eliminating a “shadow” image of the at past a light source when viewed from the liquid crystal display.

10. The liquid crystal display as recited in claim 8, wherein the diffusion section is formed by providing scattering particulates having a different refractive index, thereby having a higher diffusion capability as compared to the rest of the diffusion board.

11. The liquid crystal display as recited in claim 8, further comprising a light enhancing plate to intensify the luminance emitted from the light guide.

12. The liquid crystal display as recited in claim 8, wherein the light sources are provided with a reflector.

13. The liquid crystal display as recited in claim 11, wherein the reflector further comprises a reflected film to increase the light reflected therefrom.

14. The light crystal display as recited in claim 8, wherein the intensified diffusion section is formed of fluorescent particulates.

15. A light crystal display comprising:
a backlight module including a plurality of light sources emitting lights toward a diffusion plates, wherein
said diffusion plates defines at least first and second types regions thereof, of which the first type faces the adjacent light source in a perpendicular manner while the second type faces the adjacent light source in an obliquely manner, under a condition that diffusion capability of said first type is better than that of the second type.
